(19) United States
(12) Patent Application Publication
(10) Pub. No.: US 2023/0087117 A1
(43) Pub. Date: Mar. 23, 2023

(54) DEVICE AND METHOD FOR SAND SAMPLING THROUGH WATER METHOD

(71) Applicant: CHANG'AN UNIVERSITY, Xi'an (CN)

(72) Inventors: Hengxing LAN, Xi'an (CN); Xin LIU, Xi'an (CN); Ning ZHANG, Xi'an (CN); Hui QIN, Xi'an (CN); Xinyu XU, Xi'an (CN)

(73) Assignee: CHANG'AN UNIVERSITY, Xi'an (CN)

(21) Appl. No.: 17/798,580

(22) PCT Filed: Dec. 14, 2021
(86) PCT No.: PCT/CN2021/137772

§ 371 Date: Aug. 10, 2022

(30) Foreign Application Priority Data
Dec. 25, 2020 (CN) 202011565867.3

(51) Int. Cl. G01N 1/28; G01N 1/14; G01N 1/36; G01N 1/38

(52) U.S. Cl. CPC G01N 1/28; G01N 1/14; G01N 1/286; G01N 1/36; G01N 1/38; G01N 2001/1427; G01N 2001/362; G01N 2001/366

(57) ABSTRACT

A device for sand sampling through a water method includes a sampling cylinder and a triaxial sampler, where the sampling cylinder includes a cylinder, two ends of the cylinder being hermetically provided with an upper sealing cover and a lower sealing cover separately, one ends, facing inside of the cylinder, of the upper sealing cover and the lower sealing cover being provided with water-permeable stones, one end, facing outside of the cylinder, of the upper sealing cover being connected to a control valve, and the control valve being in communication with the inside of the cylinder; and the sampling cylinder is arranged in the triaxial sampler when sand sampling is performed through a water method, a lower end of the triaxial sampler is provided with a test operation table, and an upper end of the triaxial sampler is nested inside a restraint ring.

### CROSS REFERENCE TO THE RELATED APPLICATIONS

This application is the national stage entry of International Application No. PCT/CN2021/137772, filed on Dec. 14, 2021, which is based upon and claims priority to Chinese Patent Application No. 202011565867.3, filed on Dec. 25, 2020, the entire contents of which are incorporated herein by reference.

### TECHNICAL FIELD

The present invention belongs to the field of sand sampling through a water method, and relates to a device and a method for sand sampling through the water method.

### BACKGROUND

Soil sampling is the most basic link in geotechnical tests. Undisturbed sampling by scholars at home and abroad is limited in application range, especially to soft clay, is very high in test cost, and can only produce incomplete frozen samples since they are difficult to take out from saturators due to cementation of freezing. Undisturbed sand is more difficult to obtain since sand is more prone to be disturbed compared with clay. As thus, it is particularly important to use appropriate remolded sand sampling methods to simulate sand with different causes in laboratory tests. Common sand sampling methods currently include layered wet tamping and raining. The sand-rain method for sampling in air can simulate the characteristics of natural sand deposition, but the sampling density is difficult to control due to the sand outlet size and falling distance. Layered wet tamping is one of common sampling methods used by scholars at home and abroad to study sand liquefaction. Through this method, samples with large void ratios become possible to make, but serious soil stratification occurs and causes uniformity of the samples difficult to control. In addition, through the traditional sand sampling method, disturbance is quietly likely due to hydraulic action in the saturation process (introduction of air-free water, back pressure saturation), which leads to structural changes of the soil, and affects test results accordingly.

### SUMMARY

An objective of the present invention is to overcome the above shortcomings of the prior art, and provide a device and a method for sand sampling through a water method, through which, a saturated sand sample with an uniform density may be obtained.

In order to achieve the above objective, the present invention is implemented through the following technical solution:

The device for sand sampling through a water includes a sampling cylinder and a triaxial sampler; where

the sampling cylinder includes a cylinder, two ends of the cylinder being hermetically provided with an upper sealing cover and a lower sealing cover separately, one ends, facing inside of the cylinder, of the upper sealing cover and the lower sealing cover being provided with water-permeable stones, one end, facing outside of the cylinder, of the upper sealing cover being connected to a control valve, and the control valve being in communication with the inside of the cylinder; and

the sampling cylinder is arranged in the triaxial sampler when sand sampling is performed through a water method, a lower end of the triaxial sampler is provided with a test operation table, and an upper end of the triaxial sampler is nested inside a restraint ring.

Preferably, a rubber ring is arranged at each of a joint between the upper sealing cover and the cylinder and a joint between the lower sealing cover and the cylinder.

Preferably, the control valve is internally provided with a spring slot piston.

Preferably, the two ends of the cylinder are provided with internal threads, and peripheral surfaces of the upper sealing cover and the lower sealing cover are provided with external threads, and the upper sealing cover and the lower sealing cover are separately connected to the two ends of the cylinder in a threaded manner.

Preferably, one end, facing the outside of the cylinder, of the lower sealing cover is provided with a water valve in communication with the inside of the cylinder.

Preferably, both the upper sealing cover and the lower sealing cover are made of toughened plastic, and the cylinder is made of transparent toughened plastic.

The method for sand sampling through a water method based on the device of any one above includes:

step 1, performing sand sampling through an outdoor or indoor manner;

in the case of the outdoor manner, in an outdoor field, opening a lower sealing cover of a cylinder and a control valve, pressing one end, connected to the lower sealing cover, of the cylinder into sand, closing the control valve, and vertically lifting the cylinder upwards to obtain a sand sample; and

in the case of the indoor manner, opening an upper sealing cover of the device for sampling through a water method, injecting water into the cylinder, putting test sand into the cylinder, sealing the cylinder with the upper sealing cover, closing the control valve, and performing oscillation saturation for 5-10 minutes to obtain a sand sample; and

step 2, taking out the lower sealing cover of a sampling cylinder, nesting an upper end of a triaxial sampler in a restraint ring, placing a test operation table at a bottom of the triaxial sampler, placing the sampling cylinder in the triaxial sampler, upwards lifting the sampling cylinder to put the sand sample into the triaxial sampler until the sand sample completely enter into the triaxial sampler from the sampling cylinder, removing the restraint ring and taking out the triaxial sampler.

Preferably, after the restraint ring is removed, a pressing plate is placed above the sand sample, sucking force of 20-30 kPa is exerted to the sand sample by making a guide pipe penetrate the pressing plate and extend into the sand sample, the triaxial sampler is taken out, and a latex film is wrapped around the sand sample.

Compared with the prior art, the present invention has the following beneficial effects:

According to the present invention, through a principle of atmospheric pressure, air pressure inside the sampling cylinder is controlled by the control valve, under the action of air pressure difference between the atmospheric pressure and the air pressure inside the sampling cylinder, the original saturated sand sample may be directly extracted, thereby reducing disturbance of the soil sample. Based on the same principle, in the process of remolded saturated sand sampling, full vibration in a culture cylinder may be performed to guarantee sand and water fully contact, and finally reach a saturated state between the same. By controlling the air pressure difference, the soil samples are gradually placed inside the triaxial sampler, so as to obtain the saturated sand samples with the uniform density.

### BRIEF DESCRIPTION OF THE DRAWINGS

FIG. 1 is a schematic diagram of a sampling cylinder device of the present invention;

FIG. 2 is a front view of an upper sealing cover structure of the present invention;

FIG. 3 is a top view of the upper sealing cover structure of the present invention;

FIG. 4 is a front view of a lower sealing cover structure of the present invention;

FIG. 5 is a top view of the lower sealing cover structure of the present invention;

FIG. 6 is a flowchart of steps of sand sampling in an indoor manner of the present invention; and

FIG. 7 is a flowchart of steps of saturated sand sample loading of the present invention.

In the figures: 1—cylinder; 2—upper sealing cover; 3—lower sealing cover; 4—permeable stone; 5—control valve; 6—spring slot piston; 7—rubber ring; 8.—preparation utensil; 9—funnel; 10—guide pipe; 11—triaxial sampler; 12—test operation table; 13—restraint ring; 14—pressing plate; 15—filter paper; and 16 latex film.

### DETAILED DESCRIPTION OF THE EMBODIMENTS

The present invention will be further described below in detail with reference to accompanying drawings:

A device for sand sampling through a water method of the present invention includes a sampling cylinder and a triaxial sampler 11.

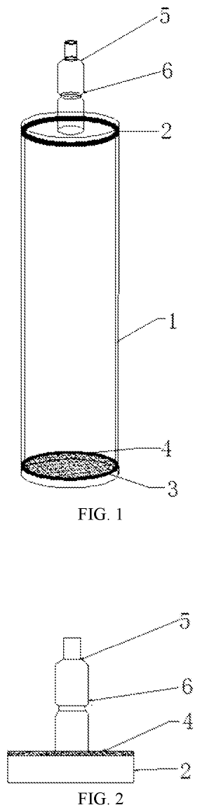

As shown in FIG. 1, the sampling cylinder includes a cylinder 1, two ends of the cylinder 1 being hermetically provided with an upper sealing cover 2 and a lower sealing cover 3 separately, one ends, facing inside of the cylinder 1, of the upper sealing cover 2 and the lower sealing cover 3 being provided with water-permeable stones 4, one end, facing outside of the cylinder 1, of the upper sealing cover 2 being connected to a control valve 5, and the control valve 5 being in communication with the inside of the cylinder 1.

The upper end and the lower end of the cylinder 1 are opened, the two ends of an inner wall of the cylinder 1 are provided with internal threads, peripheral surfaces of the upper sealing cover 2 and the lower sealing cover 3 are provided with external threads, and the upper sealing cover 2 and the lower sealing cover 3 are separately connected to the two ends of the cylinder 1 in a threaded manner.

A rubber ring 7 is arranged at each of a joint between the upper sealing cover 2 and the cylinder 1 and a joint between the lower sealing cover 3 and the cylinder 1 for guaranteeing leakproofness.

As shown in FIG. 4 and FIG. 5, the upper sealing cover 2 and the lower sealing cover 3 are made of toughened plastic, the upper sealing cover 2 has a thickness of 2 cm, the lower sealing cover 3 has a thickness of 1 cm, and a center of the upper sealing cover 2 is provided with a threaded hole.

The cylinder 1 is made of transparent toughened plastic with a thickness of 5 mm and a height of 30 cm.

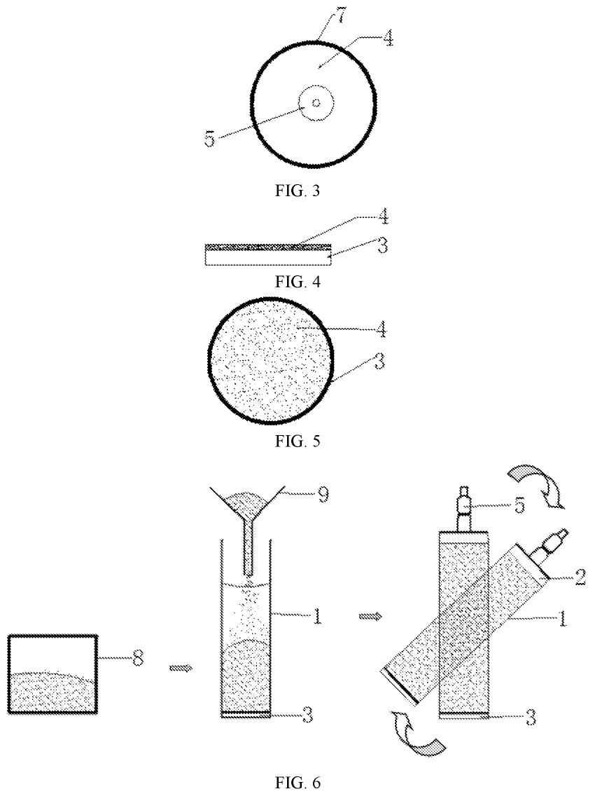

As shown in FIGS. 2 and 3, the control valve 5 is made of metallic copper, and has a length of 15 cm. A lower end of the control valve 5 is provided with a thread with a length of 2 cm, which is in screwed connection to the threaded hole in the center of the upper sealing cover 2. The control valve 5 is internally provided with a spring slot piston 6, which may be pressed to be opened and closed to control air flow and form a pressure difference between inside and outside.

The sampling cylinder is arranged in the triaxial sampler 11 when sand sampling is performed through a water method, a lower end of the triaxial sampler 11 is provided with a test operation table 12, and an upper end of the triaxial sampler 11 is nested inside a restraint ring 13. The restraint ring 13 is used for fixing a triple-split mold which constitutes the triaxial sampler 11.

Sand sampling through a water method based on the device of the present invention includes:

Step 1, sand sampling is performed through an outdoor or indoor manner.

In the case of the outdoor manner, in an outdoor field, when there is abundant water, a lower sealing cover 3 of a cylinder 1 and a control valve 5 are opened, one end, connected to the lower sealing cover 3, of the cylinder 1 is pressed into sand, the control valve 5 is closed, and the cylinder 1 is vertically lifted upwards to obtain a saturated sand sample on site.

In the case of the indoor manner, as shown in FIG. 6, a ratio of sand to water is determined according to percentages of saturated water contents of different kinds of sand, test sand is put into a preparation utensil 8, an upper sealing cover 2 of the device for sampling through a water method is opened, water is injected into the cylinder 1, the test sand is put into the cylinder 1 through a funnel 9, the cylinder 1 is sealed with the upper sealing cover 2, the control valve 5 is closed, and oscillation saturation is performed to obtain a sand sample.

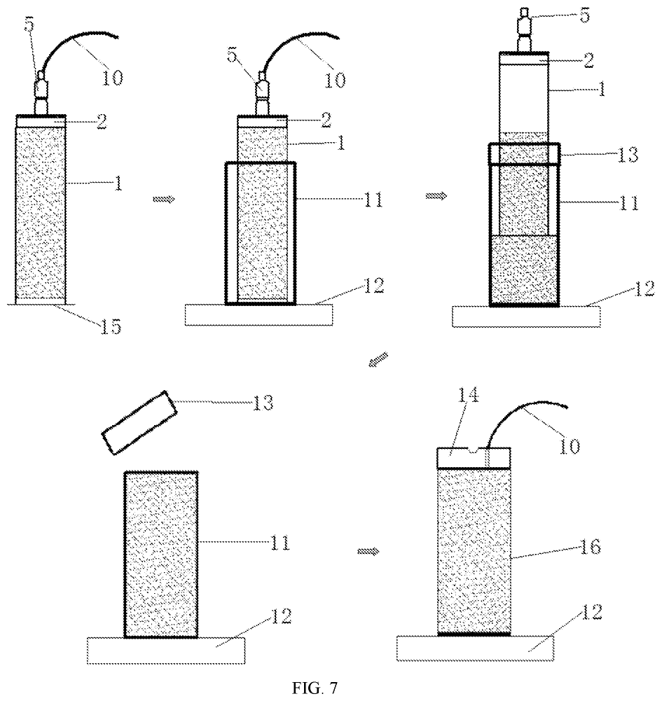

Step 2, as shown in FIG. 7, the triaxial sampler 11 and a latex film 16 are mounted on the test operation table 12, and the control valve 5 is opened. To guarantee a success rate of sampling, the control valve 5 may be connected to a guide pipe 10, and the control valve 5 is closed after certain suction force of 20-30 kPa is exerted. The lower sealing cover 3 is unscrewed, and a filter paper 15 is spread at a lower end of the sampling cylinder. After the upper end of the triaxial sampler 11 is nested inside the restraint ring 13, the cylinder 1 is put into the triaxial sampler 11, the sampling cylinder is slowly lifted upwards, the sand sample is slowly put into the triaxial sampler 11, after this process is completed, the restraint ring 13 is removed, and a pressing plate 14 is mounted above the sand sample. Suction force is exerted to the sand sample through a small hole in the pressing plate 14 and the guide pipe 10. The triaxial sampler 11 is dismounted, the latex film 16 is wrapped around the sand sample, and mounting the sand sample is completed.

What is described above is merely used for describing the technical idea of the present invention, and may not be used to limit the protection scope of the present invention. Any changes made on the basis of the technical solution and according to the technical idea proposed by the present invention shall fall within the protection scope of the claims of the present invention.

What is claimed is:

1. A device for sand sampling through a water method, comprising a sampling cylinder and a triaxial sampler; wherein
the sampling cylinder comprises a cylinder, wherein two ends of the cylinder are hermetically provided with an upper sealing cover and a lower sealing cover separately,
first ends, facing inside of the cylinder, of the upper sealing cover and the lower sealing cover are provided with water-permeable stones,
a second end, facing outside of the cylinder, of the upper sealing cover is connected to a control valve, and the control valve is in communication with the inside of the cylinder; and
the sampling cylinder is arranged in the triaxial sampler when sand sampling is performed through the water method, a lower end of the triaxial sampler is provided with a test operation table, and an upper end of the triaxial sampler is nested inside a restraint ring.

2. The device according to claim 1, wherein a rubber ring is arranged at each of a joint between the upper sealing cover and the cylinder and a joint between the lower sealing cover and the cylinder.

3. The device according to claim 1, wherein the control valve is internally provided with a spring slot piston-.

4. The device according to claim 1, wherein the two ends of the cylinder are provided with internal threads, and peripheral surfaces of the upper sealing cover and the lower sealing cover are provided with external threads, and the upper sealing cover and the lower sealing cover are separately connected to the two ends of the cylinder in a threaded manner.

5. The device according to claim 1, wherein a second end, facing the outside of the cylinder, of the lower sealing cover is provided with a water valve in communication with the inside of the cylinder.

6. The device according to claim 1, wherein the upper sealing cover and the lower sealing cover are made of toughened plastic, and the cylinder is made of transparent toughened plastic.

7. A method for sand sampling through a water method based on the device of claim 1, comprising:
step 1, performing the sand sampling through an outdoor manner or an indoor manner;
in the outdoor manner, in an outdoor field, opening the lower sealing cover of the cylinder and the control valve, pressing one end, connected to the lower sealing cover, of the cylinder into sand, closing the control valve, and vertically lifting the cylinder upwards to obtain a sand sample; and
in the indoor manner, opening the upper sealing cover of the device for sampling through the water method, injecting water into the cylinder, putting test sand into the cylinder, sealing the cylinder with the upper sealing cover, closing the control valve, and performing oscillation saturation for 5-10 minutes to obtain the sand sample; and
step 2, taking out the lower sealing cover of the cylinder, nesting the upper end of the triaxial sampler in the restraint ring, placing the test operation table at a bottom of the triaxial sampler, placing the sampling cylinder in the triaxial sampler, upwards lifting the sampling cylinder to put the sand sample into the triaxial sampler until the sand sample completely enter into the triaxial sampler from the sampling cylinder, removing the restraint ring and taking out the triaxial sampler.

8. The method according to claim 7, wherein after the restraint ring is removed, a pressing plate is placed above the sand sample, sucking force of 20-30 kPa is exerted to the sand sample by making a guide pipe penetrate the pressing plate and extend into the sand sample, the triaxial sampler is taken out, and a latex film is wrapped around the sand sample.

9. The method according to claim 7, wherein in the device, a rubber ring is arranged at each of a joint between the upper sealing cover and the cylinder and a joint between the lower sealing cover and the cylinder.

10. The method according to claim 7, wherein in the device, the control valve is internally provided with a spring slot piston.

11. The method according to claim 7, wherein in the device, the two ends of the cylinder are provided with internal threads, and peripheral surfaces of the upper sealing cover and the lower sealing cover are provided with external threads, and the upper sealing cover and the lower sealing cover are separately connected to the two ends of the cylinder in a threaded manner.

12. The method according to claim 7, wherein in the device, a second end, facing the outside of the cylinder, of the lower sealing cover is provided with a water valve in communication with the inside of the cylinder.

13. The method according to claim 7, wherein in the device, the upper sealing cover and the lower sealing cover are made of toughened plastic, and the cylinder is made of transparent toughened plastic.
